(19) United States
(12) Patent Application Publication
(10) Pub. No.: US 2015/0296428 A1
(43) Pub. Date: Oct. 15, 2015

(54) Cell Change In Discontinuous Mode

(71) Applicant: NOKIA SOLUTIONS AND NETWORKS OY, Espoo (FI)

(72) Inventors: Juergen Michel, Munich (DE); Bernhard Raaf, Neuried (DE); Seppo Ilmari Vesterinen, Oulunsalo (FI); Matti Einari Laitila, Oulu (FI)

(21) Appl. No.: 14/439,202

(22) PCT Filed: Oct. 31, 2012
(86) PCT No.: PCT/EP2012/071532

§ 371 Date: Apr. 28, 2015

(51) Int. Cl. H04W 36/00; H04W 56/00; H04W 76/02; H04W 76/04

(52) U.S. Cl. CPC H04W 36/0072; H04W 36/0016; H04W 76/048; H04W 56/00; H04W 76/021

(57) ABSTRACT

The invention relates to an apparatus including: at least one processor and at least one memory including a computer program code, the at least one memory and the computer program code configured to, with the at least one processor, cause the apparatus at least to: receive a handover indication including a terminal identifier, allocate resources to a terminal identified by the terminal identifier, and send a message indicating releasing the terminal identifier for reuse.

### FIELD

The invention relates to apparatuses, methods, systems, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In the long term evolution (LTE) or long term evolution advanced (LTE-Advanced), handovers or cell changes are mainly network controlled handovers and may be triggered on the basis of user device measurement reports or in the case a radio link failure (RLF) takes place. In general, the handover procedure may be separated into three phases: preparation phase, execution phase and completion phase.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: send a cell change indication, and if in a discontinuous reception mode, postpone synchronization with the cell change target node until the discontinuous reception mode is ended.

According to an aspect of the present invention, there is provided an apparatus comprising: at least one processor and at least one memory including a computer program code, the at least one memory and the computer program code configured to, with the at least one processor, cause the apparatus at least to: receive a cell change indication, and send a handover indication comprising a terminal identifier to be used by a cell change target node.

According to an aspect of the present invention, there is provided an apparatus comprising: at least one processor and at least one memory including a computer program code, the at least one memory and the computer program code configured to, with the at least one processor, cause the apparatus at least to: receive a handover indication comprising a terminal identifier, allocate resources to a terminal identified by the terminal identifier, and send a message indicating releasing the terminal identifier for reuse.

According to yet another aspect of the present invention, there is provided a method comprising: sending a cell change indication, and if in a discontinuous reception mode, postponing synchronization with the cell change target node until the discontinuous reception mode is ended.

According to yet another aspect of the present invention, there is provided a method comprising: receiving a cell change indication, and sending a handover indication comprising a terminal identifier to be used by a cell change target node.

According to yet another aspect of the present invention, there is provided a method comprising: receiving a handover indication comprising a terminal identifier, allocating resources to a terminal identified by the terminal identifier, and sending a message indicating releasing the terminal identifier for reuse.

According to yet another aspect of the present invention, there is provided an apparatus comprising: means for sending a cell change indication, and means for postponing synchronization with the cell change target node until the discontinuous reception mode is ended, if in a discontinuous reception mode.

According to yet another aspect of the present invention, there is provided an apparatus comprising: means for receiving a cell change indication, and means for sending a handover indication comprising a terminal identifier to be used by a cell change target node.

According to yet another aspect of the present invention, there is provided an apparatus comprising: means for receiving a handover indication comprising a terminal identifier, allocating resources to a terminal identified by the terminal identifier, and sending a message indicating releasing the terminal identifier for reuse.

According to yet another aspect of the present invention, there is provided a computer program embodied on a computer-readable storage medium, the computer program comprising program code for controlling a process to execute a process, the process comprising: sending a cell change indication, and if in a discontinuous reception mode, postponing synchronization with the cell change target node until the discontinuous reception mode is ended.

According to yet another aspect of the present invention, there is provided a computer program embodied on a computer-readable storage medium, the computer program comprising program code for controlling a process to execute a process, the process comprising: receiving a cell change indication, and sending a handover indication comprising a terminal identifier to be used by a cell change target node.

According to yet another aspect of the present invention, there is provided a computer program embodied on a computer-readable storage medium, the computer program comprising program code for controlling a process to execute a process, the process comprising: receiving a handover indication comprising a terminal identifier, allocating resources to a terminal identified by the terminal identifier, and sending a message indicating releasing the terminal identifier for reuse.

### LIST OF DRAWINGS

Some embodiments of the present invention are described below, by way of example only, with reference to the accompanying drawings, in which

FIG. 1 illustrates an example of a system;

FIG. 2 is a flow chart;

FIG. 3 shows an example of signaling;

FIG. 4 is another flow chart;

FIG. 5 is yet another flow chart;

FIG. 6 illustrates examples of apparatuses;

FIG. 7 illustrates other examples of apparatuses, and

FIG. 8 illustrates yet other examples of apparatuses.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS).

In an orthogonal frequency division multiplexing (OFDM) system, the available spectrum is divided into multiple orthogonal sub-carriers. In OFDM systems, the available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Such required information is usually signaled to the (e)NodeB.

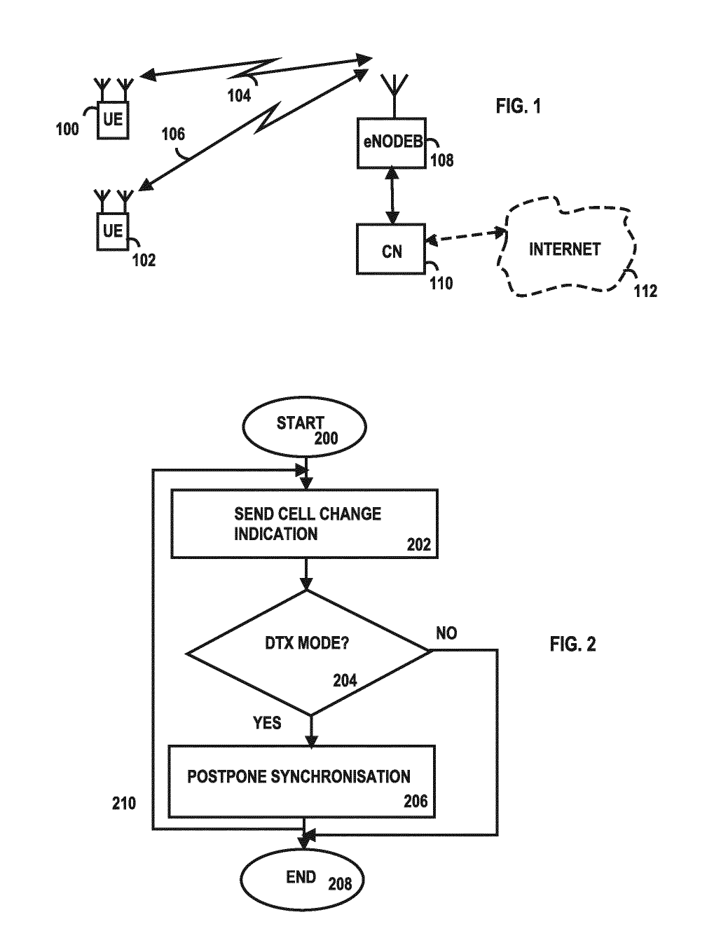

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of LTE Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104 and 106 in a cell with a (e)NodeB 108 providing the cell. The physical link from a user device to a (e)NodeB is called uplink or reverse link and the physical link from the (e)NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signaling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practice, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1 may provide any kind of these cells. A cellular radio system may be implemented as a multilayer network including several kinds of cells. Typically, in multi-layer networks, one node B provides one kind of a cell or cells, and thus a plurality of (e) Node Bs are required to provide such a network structure.

Recently for fulfilling the need for improving the deployment and performance of communication systems, the concept of “plug-and-play” (e)NodeBs has been introduced. Typically, a network which is able to use “plug-and-play” (e)Node Bs, includes, in addition to Home (e)NodeBs (H(e)nodeBs), a home node B gateway, or HNB-GW (not shown in FIG. 1). A HNB Gateway (HNB-GW), which is typically installed within an operator's network may aggregate traffic from a large number of HNBs back to a core network.

In the long term evolution (LTE) or long term evolution advanced (LTE-Advanced, handovers or cell changes are mainly network controlled handovers and may be triggered on the basis of user device measurement reports or in the case a radio link failure (RLF) takes place. In general, the handover procedure may be separated into three phases: preparation phase, execution phase and completion phase.

During the preparation phase a user device may send a measurement report to a (handover) source (e)NB. The measurement report may comprise information regarding serving cell radio signal strength and a target cell(s) physical cell identification(s) (ID) (PCI) and its radio signal strength(s). Based on this a handover decision may be made at the source (e)NB and a handover request message may be send to the target (e)NB. The handover request message may comprise information regarding the user device's aggregate maximum bit rate and the E-UTRAN radio access bearer (E-RAB) route.

If the handover request is accepted by the target (e)NB, it may reply using a handover request acknowledgement message after establishing an uplink S1 bearer to a serving gateway (SGW). The message may comprise information for the setup of the X2 transport bearer between the source (e)NB and the target (e)NB and a handover command related information like a cell radio network temporary identifier (C-RNTI), or one or more suitable parameters to be used by a user terminal in the target cell.

As soon as the handover preparation has been carried out, the execution phase may start with the user device receiving the handover command for radio resource control (RRC) connection reconfiguration. The user device may detach from the source (e)NB, and sequence number (SN) status transfer as well as a random access procedure for synchronization may be carried out.

From the target (e)NB point of view, the user device uplink resource allocation for data transmission may be carried out. The user device may confirm the handover (RRC connection reconfiguration) using the C-RNTI allocated by the target (e)NB. With this a data radio bearer (DRB) between the user device and a new serving (the target) (e)NB may be established.

Embodiments are suitable for E-UTRAN (evolved UMTS terrestrial radio access network) handover/cell selection procedure.

It should be appreciated that the coding of software for carrying out the embodiments shown and described below is well within the scope of a person of ordinary skill in the art.

It should be appreciated that in the case of small cells, energy efficient discontinuous transmission/reception (DRX) operation, heterogeneous deployments and/or local area cells, the handover efficiency with the network centric approach described above may not be advantageous for a plurality of applications, such as background-run e-mail checking or background-run signaling from smart-phones or similar devices, or in general for applications with bursty traffic characteristics. As an exemplifying scenario it is taken a user device which is moving in a small coverage area cell network environment and with bursty data activity, typically with short temporal breaks or low activity background signaling. Usually, a plurality of handovers has to be conducted with a typical network centric handover approach. However, due to the traffic characteristic, significant amount of data exchange between the user device and an (e)NB does not usually take place. Therefore, handovers are partly carried out unnecessarily and it would be beneficial, if such unnecessary handovers (or cell changes) can be avoided, optimized and/or delayed. Thus, it is proposed that the handover preparation and execution phases are changed from network-centric to user device-centric in such a manner that the decision to carry out a handover is made by the user device, even though a network may configure one or more criteria to be used in the decision making by the user device. Such criteria may comprise an offset indicating that the user device should only change to a specific cell, if the reception quality is better than that of the current cell added by the specified offset.

An embodiment is suitable for a user device-centric handover or cell change procedure and to be carried out by a user device. The embodiment starts in block 200 of FIG. 2.

In block 202, a cell change indication is sent.

The cell change indication may comprise a terminal identifier aimed to be used by a cell change source node and a cell change target node in identifying the user device at issue.

A terminal identifier may be a cell radio network temporary identifier (C-RNTI) and the same terminal identifier is used by both a source (e)NB and a target (e)NB. The terminal identifier may be set to be used in an area covering a plurality of cells in order to avoid having to reconfigure it during a handover execution phase.

The usage of a terminal identifier is useful for a target (e)NB to identify the incoming user device especially when only a minimum of handover related information that is a cell change indication is exchanged between the user device and a source (e)NB. This approach provides an option to decrease signaling between source and target (e)NBs and/or a user device.

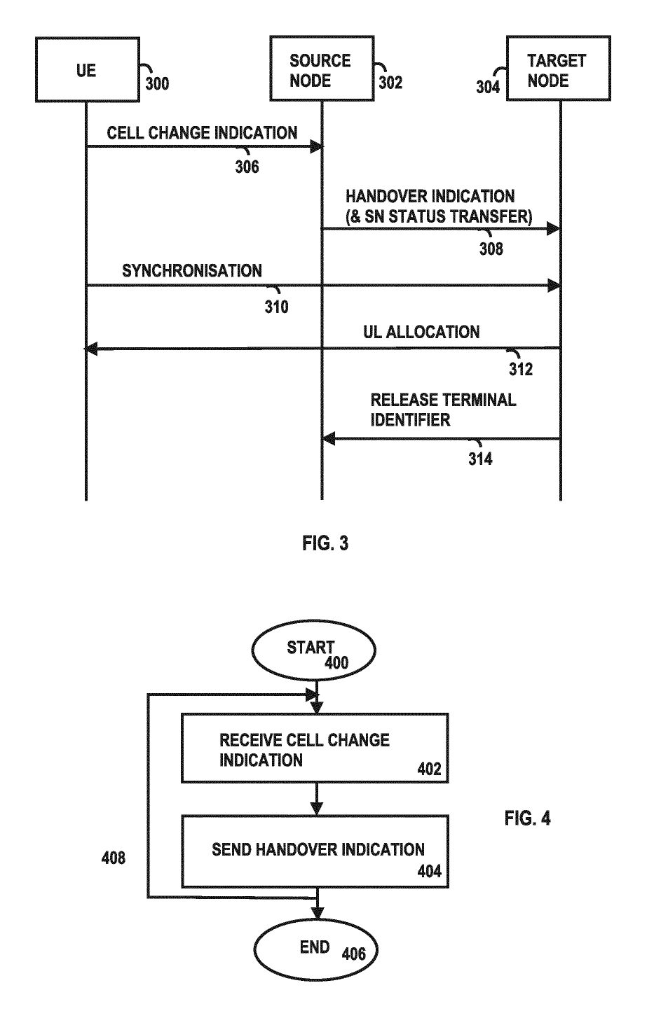

FIG. 3 illustrates an example of messages and/or operations carried out between a user device and network elements source node and target node (in this example terms source (e)NB and target (e)NB are used, but the terminology is non-limiting). In the FIG. 3, user device 300 informs source (e)NB 302, that a cell change is to be carried out by message 306 comprising a cell change indication. The trigger condition on which to decide on a cell change and thus send a cell change indication may be determined by the network and either signaled via higher layers user device-wise or cell-specifically by using broadcast information.

A user device may settle on a single target (e)NB or it may have a plurality of target (e)NB candidates for a cell change. This selection may be indicated to a source (e)NB using the cell change indication message. Selecting a plurality of target (e)NB candidates may be particularly relevant in the case the user device is in a discontinuous transmission/reception (DTX) mode after leaving the source (e)NB (i.e. no active data communication is taking place) and may only become active once it reaches a next (e)NB, which is one of the target (e)NB candidates. The candidates may be selected on the basis of measurements made by the user device and/or they may be selected by the (e)NB utilizing the knowledge of topology. In the last option, the candidates may be informed to the user device.

After sending a cell change indication, the user device may release the connection to the source (e)NB.

If in a discontinuous reception mode (204), synchronization is postponed with the cell change target node until the discontinuous reception mode is ended (block 206).

In an example, when subsequently uplink data is available for transmission at a user device, it ends the DRX mode, transmits the synchronization message and carries out data transmission. In this manner, potentially unnecessary signaling may be decreased or even avoided, in particular synchronization to a new cell, until data is to be transferred. If the user device is moving, it may even be in a DRX mode the whole time it is under a certain cell and synchronization to this cell may not be necessary at all. Another option may be that the user device is in an idle mode and carries out an idle mode cell change rather than a handover.

In the example of FIG. 3, the synchronization message comprising timing advance (TA) information is marked with reference number 310.

In a user device-centric handover or cell change, the user device may, typically due to bad channel conditions, disappear without being aware that a source (e)NB does not detect this. This may take place when the user device is in a DTX mode and delays a synchronization message. Therefore the user device is usually not yet registered in a target (e)NB. If downlink data for the user device is arriving, it is routed erroneously to the source (e)NB. Without noticing the user device-centric handover decision, the source (e)NB may send this data to the user device. However the data does not reach the user device as it has already left the coverage area of the source (e)NB. To recover from this, the information on the location of the user device on cell level typically needs to be established. Therefore, a similar mechanism to paging in an idle mode may be carried out. Additionally, the data erroneously routed, needs to be re-routed from the source (e)NB to the target (e)NB and further to the user device.

To avoid the above explained error, a cell change error restoration procedure may be applied. In this procedure, a physical layer ACK (acknowledgement), to acknowledge the user device cell change indication, may be transmitted to the user device by a source (e)NB in the case it receives a cell change indication message for the user device. This ACK may be the same or a similar message as the acknowledgement that is used to implement hybrid automatic retransmission request (HARQ) or automatic retransmission request (ARQ).

To improve the reliability of this ACK and reduce the induced other cell interference, information on the required estimated coding strength or transmission power of the ACK may also be added to the cell change message. This may be for example information about the current path-loss and/or how fast the received signal strength of a source (e)NB is degrading (dB/s).

In the case the channel conditions are so bad that it is unlikely the user device to be able to receive the acknowledgement, the ACK may be transmitted by a target (e)NB. In this case the source (e)NB may not even try to send the ACK itself. Instead, it may forward a request to acknowledge the cell change indication to the target (e)NB which will transmit the acknowledgement to the user device. This request may be “piggybacked” with the cell change indication to be sent anyhow, when the X2 interface and protocol may be used. On the physical layer this acknowledgement is typically to be sent in a different manner than that of the acknowledgement for HARQ operation (which is typically sent on a dedicated physical resource). One option is to use a control signaling resource on a physical downlink control channel (PDCCH). Another option is to integrate ACK into the synchronization procedure triggered by the user device on the target (e)NB.

In the following, some possible error situations and restoration procedures with regard to them are explained in further detail.

In the first example, a cell change indication is not received by a source (e)NB. From the user device's perspective this means that DTX or no-acknowledgement (NACK) instead of an ACK is detected (acknowledgement is not received). Then the user device introduces itself by sending to a cell change target (e)NB a cell change indication message comprising a source (e)NB identity. In the case the user device is in a DRX mode, the user device does not delay a synchronization procedure (in order to send the cell change indication message to the target (e)NB).

In the second example, a source (e)NB receives a cell change indication from a user device, but ACK to confirm the cell change indication is lost (the user device decodes DTX instead of an ACK). Then the user device sends the cell change indication to a target (e)NB without delaying synchronization. In the third example, a target (e)NB receives both a handover indication from a source (e)NB and a cell change indication from the user device. The cell change target (e)NB ACKs the cell change indication message to the user device in order to make the user device aware that the cell change indication message was correctly understood by the network. The target (e)NB typically also transmits uplink allocation message to the user device.

The embodiment ends in block 208. The embodiment is repeatable in many ways. One example is shown by arrow 210 in FIG. 2.

Another embodiment is suitable for a user device-centric handover or cell change procedure and to be carried out by a node designed to operate as a cell change source node. The embodiment starts in block 400 of FIG. 4.

In block 402, a cell change indication is received.

The cell change indication may comprise a terminal identifier aimed to be used by the cell change source node and a cell change target node in identifying the user device at issue.

A terminal identifier may be a C-RNTI and the same terminal identifier is used by both a source (e)NB and a target (e)NB. The terminal identifier may be set to be used in an area covering a plurality of cells in order to avoid having to reconfigure it during a handover execution phase.

A user device may settle on a single target (e)NB or it may have a plurality of target (e)NB candidates for a cell change. This selection may be indicated to a source (e)NB as a part of the cell change indication. In the case of a plurality of target (e)NB candidates, one of them may be named as a primary cell change target node, which may also be indicated to the node.

FIG. 3 illustrates an example of messages and/or operations carried out between user device and network elements source node and target node (in this example terms source (e)NB and target (e)NB are used, but the terminology is non-limiting). In the Figure, user device 300 informs source (e)NB 302, that a cell change is to be carried out by message 306 comprising a cell change indication. The trigger for the cell change indication is usually determined by the network and either signaled via higher layers user device-wise or cell-specifically by using broadcast information.

In block 404 (of FIG. 4), a handover indication comprising a terminal identifier to be used by to cell change target node is sent.

In the case the user device has a plurality of candidates to a target (e)NB, the handover indication may be sent to all potential target cells or to a primary target cell which may retrieve the handover indication when needed. The information about the primary target may be obtained from the user device.

In addition to the terminal identifier other information may also be conveyed, such as a target data radio bearer (DRB) identifier ID, which is designed to be unique and non-ambiguously known by both a user device and a target (e)NB. The information may be pre-known or pre-defined by the user device and/or the target (e)NB or the target (e)NB may retrieve the information from a source (e)NB via signaling.

The handover indication may be signaled with “sequence number (SN) status transfer” message similar to that of the prior art.

If the user device is in a connected mode, the source (e)NB may start forwarding downlink data packets to the target (e)NB. Additionally, the source (e)NB may receive a message from the target (e)NB that the terminal identifier may be released for reuse once the user device is not anymore connected or at least not in the area wherein this terminal identifier was reserved to be used for that user device.

In the case the user device has only one target (e)NB, the source (e)NB may start downlink (DL) data forwarding to the target (e)NB after the cell handover indication and status transfer message are conveyed. On the other hand, if the user device has a plurality of target (e)NB candidates, the source (e)NB may use a pre-defined multicast Internet protocol (IP) address for data forwarding.

In the example of FIG. 3, the source (e)NB 302 sends a “handover indication & SN status transfer” message 308 to the target (e)NB 304.

In a user device-centric handover or cell change, the user device may, typically due to bad channel conditions, disappear without being aware that a source (e)NB does not detect this. This may take place when the user device is in a DTX mode and delays a synchronization message. Therefore the user device is usually not yet registered in a target (e)NB. If downlink data for the user device is arriving, it is routed erroneously to the source (e)NB. Without noticing the user device-centric handover decision, the source (e)NB may send this data to the user device. To recover from this, the information on the location of the user device on cell level typically needs to be established. Therefore, a similar mechanism to paging in an idle mode may be carried out. Additionally, the data erroneously routed, needs to be re-routed from the source (e)NB to the target (e)NB and further to the user device.

To avoid the above explained error, a cell change error restoration procedure may be applied. In this procedure, a physical layer ACK, to acknowledge the user device handover indication, may be transmitted to the user device by a source (e)NB in the case it receives a cell change indication message for the user device. This ACK may be the same or a similar message as the acknowledgement that is used to implement hybrid automatic retransmission request (HARQ) or automatic retransmission request (ARQ).

To improve the reliability of this ACK and reduce the induced other cell interference, information on the required estimated coding strength or transmission power of the ACK may also be added to the cell change message. This may be for example information about the current path-loss and/or how fast the received signal strength of a source (e)NB is degrading (dB/s).

In the case the channel conditions are so bad that it is unlikely the user device to be able to receive the acknowledgement, the ACK may be transmitted by a target (e)NB. In this case the source (e)NB may not even try to send the ACK itself. Instead, it may forward a request to acknowledge the cell change indication to the target (e)NB which will transmit the acknowledgement to the user device. This request may be “piggybacked” with the cell change indication to be sent anyhow, when the X2 interface and protocol may be used. On the physical layer this acknowledgement is typically to be sent in a different manner than that of the acknowledgement for HARQ operation (which is typically sent on a dedicated physical resource). One option is to use a control signaling resource on a physical downlink control channel (PDCCH). Another option is to integrate ACK into the synchronization procedure triggered by the user device on the target (e)NB.

In the following, some possible error situations and restoration procedures with regard to them are explained in further detail.

In the first example, a source node does not manage to receive a cell change indication from a user device but, instead, receives a handover indication from a target (e)NB, then the source (e)NB sends an SN status information to the target (e)NB as a response to the handover indication message.

In the second example, a source (e)NB receives both a cell change indication from a user device and a handover indication from a target (e)NB, then the source (e)NB ignores the handover indication from the target (e)NB, if it has already received the cell change indication from the user device and sends a SN status transfer message to the target (e)NB.

The embodiment ends in block 406. The embodiment is repeatable in many ways. One example is shown by arrow 408 in FIG. 4.

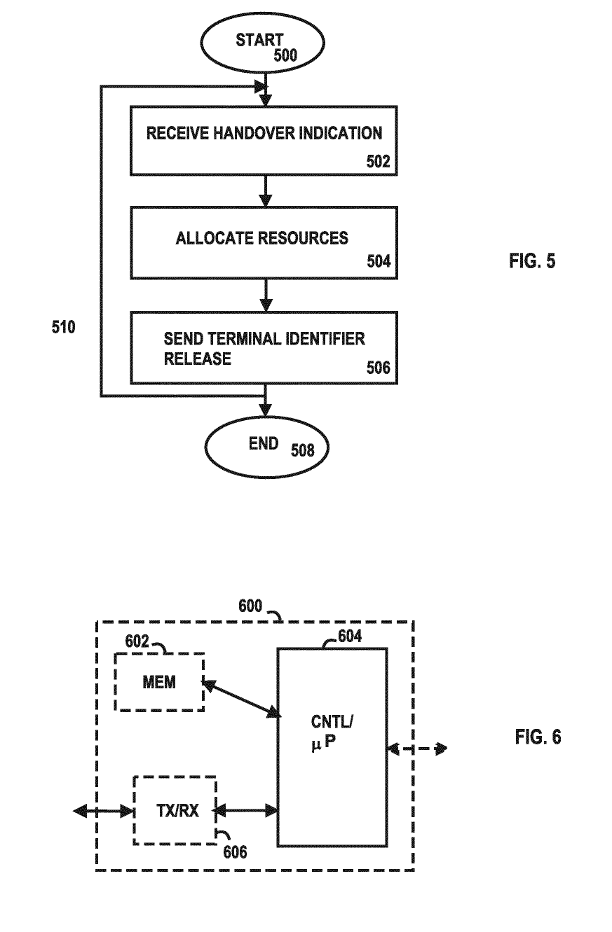

Yet another embodiment is suitable for a user device-centric handover or cell change procedure and to be carried out by a node designed to operate as a cell change target node. The embodiment starts in block 500 of FIG. 5.

In block 502, a handover indication comprising a terminal identifier is received.

The terminal identifier may be used by the cell change source node and a cell change target node in identifying the user device at issue.

A terminal identifier may be a C-RNTI and the same terminal identifier is used by both a source (e)NB and a target (e)NB. The terminal identifier may be set to be used in an area covering a plurality of cells in order to avoid having to reconfigure it during a handover execution phase.

FIG. 3 illustrates an example of messages and/or operations carried out between user device and network elements source node and target node (in this example terms source (e)NB and target (e)NB are used, but the terminology is non-limiting). In the Figure, source (e)NB 302 sends a handover indication message (308) to target (e)NB 304.

In addition to a terminal identifier, other information may also be conveyed by a handover indication, such as a target data radio bearer (DRB) identifier (ID), which is designed to be unique and non-ambiguously known by both a user device and a target (e)NB. The information may be pre-known or pre-defined by the user device and/or the target (e)NB or the target (e)NB may retrieve the information from a source (e)NB via signaling.

The handover indication may be signaled with “sequence number (SN) status transfer” message similar to that of the prior art.

In block 504, resources are allocated to a terminal identified by the terminal identifier.

This resource allocation may be carried out as in a normal handover procedure of a user device. The allocation message is depicted in the example of FIG. 3 by reference number 312.

In block 506, a message indicating releasing the terminal identifier for reuse is sent.

The source (e)NB may be informed that a terminal identifier is free to reuse. If the user device is later on going into idle mode after some data transmission in the target cell or is leaving the area where the terminal identifier is unique, the target (e)NB may inform the source (e)NB that the identifier may be reused again. The signaling may be triggered by the (e)NB to which the user device terminates the connection or leaves the local area where the terminal identifier is valid (in which case a plurality of (e)NBs may be involved and the signaling may be carried out by a primary target (e)NB). In The example of FIG. 3, the release message is depicted by reference number 314.

In a user device-centric handover or cell change, the user device may, typically due to bad channel conditions, disappear without being aware that a source (e)NB does not detect this. This may take place when the user device is in a DTX mode and delays a synchronization message. Therefore the user device is usually not yet registered in a target (e)NB. If downlink data for the user device is arriving, it is routed erroneously to the source (e)NB. Without noticing the user device-centric handover decision, the source (e)NB may send this data to the user device. To recover from this, the information on the location of the user device on cell level typically needs to be established. Therefore, a similar mechanism to paging in an idle mode may be carried out. Additionally, the data erroneously routed, needs to be re-routed from the source (e)NB to the target (e)NB and further to the user device.

To avoid the above explained error, a cell change error restoration procedure may be applied. In this procedure, a physical layer ACK, to acknowledge the user device handover indication, may be transmitted to the user device by a source (e)NB in the case it receives a cell change indication message for the user device. This ACK may be the same or a similar message as the acknowledgement that is used to implement hybrid automatic retransmission request (HARQ) or automatic retransmission request (ARQ).

To improve the reliability of this ACK and reduce the induced other cell interference, information on the required estimated coding strength or transmission power of the ACK may also be added to the cell change message. This may be for example information about the current path-loss and/or how fast the received signal strength of a source (e)NB is degrading (dB/s).

In the case the channel conditions are so bad that it is very unlikely the user device to be able to receive the acknowledgement, the ACK may be transmitted by a target (e)NB. In this case the source (e)NB may not even try to send the ACK itself. Instead, it may forward a request to acknowledge the cell change indication to the target (e)NB which will transmit the acknowledgement to the user device. This request may be “piggybacked” with the cell change indication to be sent anyhow, when the X2 interface and protocol may be used. On the physical layer this acknowledgement is typically to be sent in a different manner than that of the acknowledgement for HARQ operation (which is typically sent on a dedicated physical resource). One option is to use a control signaling resource on a physical downlink control channel (PDCCH). Another option is to integrate ACK into the synchronization procedure triggered by the user device on the target (e)NB.

In the following, some possible error situations and restoration procedures with regard to them are explained in further detail.

In the first example, a cell change indication is not received by a source (e)NB. Then the user device sends a cell change indication message comprising a source (e)NB identity to the target (e)NB. In the case the user device is in a DRX mode, the user device does not delay a synchronization procedure. Then the target (e)NB sends a handover indication to the source (e)NB and the source (e)NB responses by sending SN status information to the target (e)NB.

In the second example, a target (e)NB receives a cell change indication from a user device and then the target (e)NB notifies the handover to a source (e)NB by sending a handover indication message to the source (e)NB. However, if the target (e)NB has already received an SN status transfer from the source (e)NB, it may omit the indicating of the handover to the source (e)NB. The case described herein may take place if the source (e)NB acknowledges the cell change indication from the user device, but the user device misses or loses this acknowledgement, due to bad channel conditions with the source (e)NB, for example.

In the third example, a target (e)NB receives both a cell change indication from a user device and a handover indication from a source (e)NB. Then the target (e)NB acknowledges the cell change indication to the user device by sending a cell change acknowledge. It may also send an uplink allocation message to the user device. No need to send the handover indication back to the source (e)NB exists as it is already aware of the handover. However, depending on the timing and delay of the different backhaul messages, it is possible that the handover indication from the source (e)NB arrives at the target (e)NB after the cell change indication from the user device. Then the target (e)NB may still send the handover indication to the source (e)NB which will identify this as an error and realize that it does not have to resend the SN status transfer. The target (e)NB, when receiving the delayed handover indication and SN status transfer, realizes that it may ignore the handover indication and consider only the SN status transfer.

The embodiment ends in block 508. The embodiment is repeatable in many ways. One example is shown by arrow 510 in FIG. 5.

The steps/points, signaling messages and related functions described above in FIGS. 2, 3, 4 and 5 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, broadcasting, signaling transmitting and/or receiving may herein mean preparing a data conveyance, broadcast, transmission and/or reception, preparing a message to be conveyed, broadcasted, signaled, transmitted and/or received, or physical transmission and/or reception itself, etc. on a case by case basis. The same principle may be applied to terms transmission and reception as well.

An embodiment provides an apparatus which may be a user device or another suitable apparatus capable to carry out processes described above in relation to FIG. 2.

It should be appreciated that the apparatus may include or otherwise be in communication with a control unit, one or more processors or other entities capable of carrying out operations according to the embodiments described by means of FIG. 2. It should be understood that each block of the flowchart of FIG. 2 and any combination thereof may be implemented by various means or their combinations, such as hardware, software, firmware, one or more processors and/or circuitry.

FIG. 6 illustrates a simplified block diagram of an apparatus according to an embodiment in relation to FIG. 2.

As an example of an apparatus according to an embodiment, it is shown apparatus 600, such as a user device, including facilities in control unit 604 (including one or more processors, for example) to carry out functions of embodiments according to FIG. 6. The facilities may be software, hardware or combinations thereof as described in further detail below.

In FIG. 6, block 606 includes parts/units/modules needed for reception and transmission, usually called a radio front end, RF-parts, radio parts, radio head, etc.

Another example of apparatus 600 may include at least one processor 604 and at least one memory 602 including a computer program code, the at least one memory and the computer program code configured to, with the at least one processor, cause the apparatus at least to: send a cell change indication, and if in a discontinuous reception mode, postpone synchronization with the cell change target node until the discontinuous reception mode is ended.

Yet another example of an apparatus comprises means 604 (606) for sending a cell change indication, and means 604 (606) for postponing synchronization with the cell change target node until the discontinuous reception mode is ended, if in a discontinuous reception mode.

Yet another example of an apparatus comprises a transmitting unit configured to send a cell change indication, and a controller configured to postpone synchronization with the cell change target node until the discontinuous reception mode is ended, if in a discontinuous reception mode.

It should be understood that the apparatuses may include or be coupled to other units or modules etc., such as radio parts or radio heads, used in or for transmission and/or reception. This is depicted in FIG. 6 as optional block 606.

Although the apparatuses have been depicted as one entity in FIG. 6, different modules and memory may be implemented in one or more physical or logical entities.

Another embodiment provides an apparatus which may be a node, server, host or another suitable apparatus capable to carry out processes described above in relation to FIG. 4.

It should be appreciated that the apparatus may include or otherwise be in communication with a control unit, one or more processors or other entities capable of carrying out operations according to the embodiments described by means of FIG. 4. It should be understood that each block of the flowchart of FIG. 4 and any combination thereof may be implemented by various means or their combinations, such as hardware, software, firmware, one or more processors and/or circuitry.

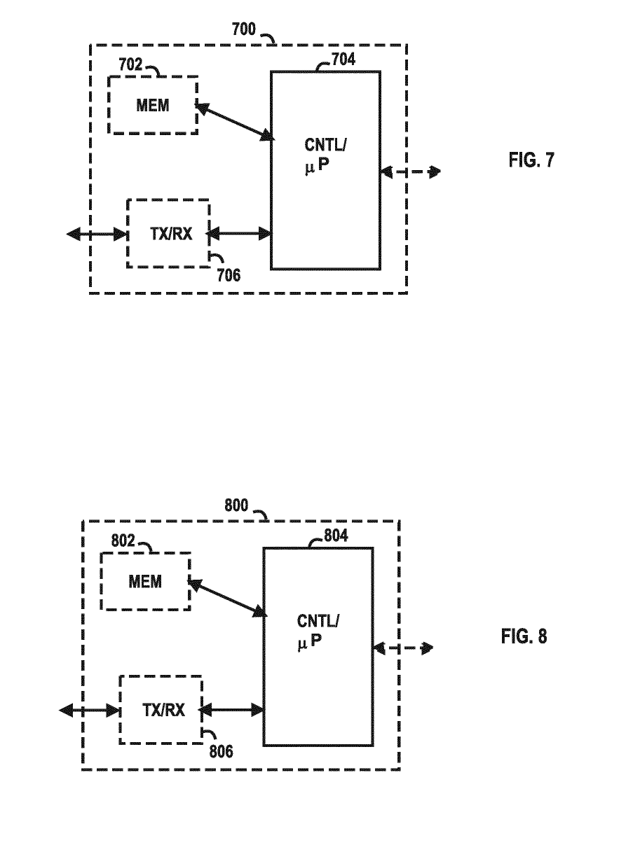

FIG. 7 illustrates a simplified block diagram of an apparatus according to an embodiment in relation to FIG. 4.

As an example of an apparatus according to an embodiment, it is shown apparatus 700, such as a node, including facilities in control unit 704 (including one or more processors, for example) to carry out functions of embodiments according to FIG. 7. The facilities may be software, hardware or combinations thereof as described in further detail below.

In FIG. 7, block 706 includes parts/units/modules needed for reception and transmission, usually called a radio front end, RF-parts, radio parts, radio head, etc.

Another example of apparatus 700 may include at least one processor 704 and at least one memory 702 including a computer program code, the at least one memory and the computer program code configured to, with the at least one processor, cause the apparatus at least to: receive a cell change indication, and send a handover indication comprising a terminal identifier to be used by a cell change target node.

Yet another example of an apparatus comprises means 704 (706) for receiving a cell change indication, and means 704 (706) for sending a handover indication comprising a terminal identifier to be used by a cell change target node.

Yet another example of an apparatus comprises a receiving unit configured to receive a cell change indication, and a sending unit configured to send a handover indication comprising a terminal identifier to be used by a cell change target node.

It should be understood that the apparatuses may include or be coupled to other units or modules etc., such as radio parts or radio heads, used in or for transmission and/or reception. This is depicted in FIG. 7 as optional block 706.

Although the apparatuses have been depicted as one entity in FIG. 7, different modules and memory may be implemented in one or more physical or logical entities.

Yet another embodiment provides an apparatus which may be a node, host or server or another suitable apparatus capable to carry out processes described above in relation to FIG. 5.

It should be appreciated that an apparatus may include or otherwise be in communication with a control unit, one or more processors or other entities capable of carrying out operations according to the embodiments described by means of FIG. 5. It should be understood that each block of the flowchart of FIG. 5 and any combination thereof may be implemented by various means or their combinations, such as hardware, software, firmware, one or more processors and/or circuitry.

FIG. 8 illustrates a simplified block diagram of an apparatus according to an embodiment in relation to FIG. 5.

As an example of an apparatus according to an embodiment, it is shown apparatus 800, such as a node, including facilities in control unit 804 (including one or more processors, for example) to carry out functions of embodiments according to FIG. 8. The facilities may be software, hardware or combinations thereof as described in further detail below.

In FIG. 8, block 806 includes parts/units/modules needed for reception and transmission, usually called a radio front end, RF-parts, radio parts, radio head, etc.

Another example of apparatus 800 may include at least one processor 804 and at least one memory 802 including a computer program code, the at least one memory and the computer program code configured to, with the at least one processor, cause the apparatus at least to: receive a handover indication comprising a terminal identifier, allocate resources to a terminal identified by the terminal identifier, and send a message indicating releasing the terminal identifier for reuse.

Yet another example of an apparatus comprises means 804 (806) for receiving a handover indication comprising a terminal identifier, means 804 for allocating resources to a terminal identified by the terminal identifier, and means 804 (806) for sending a message indicating releasing the terminal identifier for reuse.

Yet another example of an apparatus comprises a receiving unit configured to receive a handover indication comprising a terminal identifier, an allocator configured to allocate resources to a terminal identified by the terminal identifier, and a sending unit configured to send a message indicating releasing the terminal identifier for reuse.

It should be understood that the apparatuses may include or be coupled to other units or modules etc., such as radio parts or radio heads, used in or for transmission and/or reception. This is depicted in FIG. 8 as optional block 806.

Although the apparatuses have been depicted as one entity in FIG. 8, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be, include or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Computer programs may be coded by a programming language, which may be a high-level programming language, such as objective-C, C, C++, C#, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
send a cell change indication,
and if in a discontinuous reception mode,
postpone synchronization with the cell change target node until the discontinuous reception mode is ended.

2. The apparatus of claim 1, wherein the cell change indication comprises a terminal identifier, the terminal identifier being aimed to be used by a cell change source node and a cell change target node.

3. The apparatus of claim 1, wherein the terminal identifier is a cell radio net-work temporary identifier (C-RNTI).

4. The apparatus of claim 2, wherein the terminal identifier is set for an area covering a plurality of cells.

5. The apparatus of claim 1, further comprising causing the apparatus to:
choose one target node or a plurality of target node candidates, and
indicate the chosen one target node or a plurality of target node candidates to a source node in relation to the cell change indication.

6. The apparatus of claim 1, further comprising causing the apparatus to:
send the cell change indication to the cell change source node and
if a cell change indication acknowledgement is not received,
send the cell change indication to the cell change target node, the cell change indication comprising identity information of the cell change source node and if in a discontinuous reception mode, omit the postponing of synchronization.

7. The apparatus of claim 6, further comprising causing the apparatus to:
receive a cell change indication acknowledgement from the cell change target node.

8. The apparatus of claim 1, the apparatus comprising a user device.

9. (canceled)

10. An apparatus comprising:
at least one processor and at least one memory including a computer program code, the at least one memory and the computer program code configured to, with the at least one processor, cause the apparatus at least to:
receive a cell change indication, and
send a handover indication comprising a terminal identifier to be used by a cell change target node.

11. The apparatus of claim 10, wherein the cell change indication comprises the terminal identifier being aimed to be used by a cell change source node and a cell change target node.

12. The apparatus of claim 10, further comprising causing the apparatus to:
receive information on a cell change target node or a plurality of cell change target node candidates of which one is a primary cell change target node.

13. The apparatus of claim 10, wherein the handover indication is sent to the cell change target node, to the plurality of cell change target node candidates or to the primary cell change target node.

14. The apparatus of claim 10, further comprising causing the apparatus to:
if the cell change indication is not received, but a handover indication from the cell change target node is received, send a sequence number (SN) status information as a response to the handover indication and omit the sending of the handover indication.

15-16. (canceled)

17. An apparatus comprising:
at least one processor and at least one memory including a computer program code, the at least one memory and the computer program code configured to, with the at least one processor, cause the apparatus at least to:
receive a handover indication comprising a terminal identifier;
allocate resources to a terminal identified by the terminal identifier, and
send a message indicating releasing the terminal identifier for reuse.

18. The apparatus of claim 17, wherein the terminal identifier is aimed to be used by the cell change source node and a cell change target node.

19. The apparatus of claim 17, further comprising causing the apparatus to:
if instead of the handover indication a cell change indication is received, send a handover indication to the cell change source node.

20. The apparatus of claim 19, further comprising causing the apparatus to:
if sequence number status transfer is received from the cell change source node, omit the sending of the handover indication to the cell change source node.

21. The apparatus of claim 17, further comprising causing the apparatus to:
receive a cell change indication from a user device, and
acknowledge the cell change indication.

22-23. (canceled)

24. A method comprising:
sending a cell change indication, and if in a discontinuous reception mode,
postponing synchronization with the cell change target node until the discontinuous reception mode is ended.

25. The method of claim 24, wherein the cell change indication comprises a terminal identifier, the terminal identifier being aimed to be used by a cell change source node and a cell change target node.

26. The method of claim 24, wherein the terminal identifier is a cell radio network temporary identifier (C-RNTI).

27. The method of claim 25, wherein the terminal identifier is set for an area covering a plurality of cells.

28. The method of claim 24, further comprising:
choosing one target node or a plurality of target node candidates, and
indicating the chosen one target node or a plurality of target node candidates to a source node in relation to the cell change indication.

29. The method of claim 24, further comprising:
sending the cell change indication to the cell change source node and if a cell change indication acknowledgement is not received,
sending the cell change indication to the cell change target node, the cell change indication comprising identity information of the cell change source node and if in a discontinuous reception mode, omitting the postponing of synchronization.

30. The method of claim 29, further comprising:
receiving a cell change indication acknowledgement from the cell change target node.

31. (canceled)

32. A method comprising:
receiving a cell change indication, and
sending a handover indication comprising a terminal identifier to be used by a cell change target node.

33. The method of claim 32, wherein the cell change indication comprises the terminal identifier being aimed to be used by a cell change source node and a cell change target node.

34. The method of claim 32, further comprising:
receiving information on a cell change target node or a plurality of cell change target node candidates of which one is a primary cell change target node.

35. The method of claim 32, wherein the handover indication is sent to the cell change target node, to the plurality of cell change target node candidates or to the primary cell change target node.

36. The method of claim 32, further comprising:
if the cell change indication is not received, but a handover indication from the cell change target node is received,
sending a sequence number (SN) status information as a response to the handover indication and omit the sending of the handover indication.

37. (canceled)

38. A method comprising:
receiving a handover indication comprising a terminal identifier;
allocating resources to a terminal identified by the terminal identifier, and
sending a message indicating releasing the terminal identifier for reuse.

39. The method of claim 38, wherein the terminal identifier is aimed to be used by the cell change source node and a cell change target node.

40. The method of claim 38, further comprising:
if instead of the handover indication a cell change indication is received,
sending a handover indication to the cell change source node.

41. The method of claim 40, further comprising:
if sequence number status transfer is received from the cell change source node,
omitting the sending of the handover indication to the cell change source node.

42. The method of claim 38, further comprising:
receiving a cell change indication from a user device, and
acknowledging the cell change indication.

43-46. (canceled)
